(19) United States
(12) Patent Application Publication
(10) Pub. No.: US 2010/0109974 A1
(43) Pub. Date: May 6, 2010

(54) SYSTEM FOR SUPPLYING VARYING CONTENT TO MULTIPLE DISPLAYS USING A SINGLE PLAYER

(75) Inventors: William DUNN, Alpharetta, GA (US); Gerald Fraschilla, Snellville, GA (US); Rick DeLaet, Snellville, GA (US)

Correspondence Address: STANDLEY LAW GROUP LLP, 6300 Riverside Drive, Dublin, OH, 43017, US

(73) Assignee: MANUFACTURING RESOURCES INTERNATIONAL, INC., Alpharetta, GA (US)

(21) Appl. No.: 12/568,896

(22) Filed: Sep. 29, 2009

Related U.S. Application Data
(63) Continuation-in-part of application No. 12/422,037, filed on Apr. 10, 2009.
Application No. 12/422,037 is a continuation-in-part of application No. 12/418,250, filed on Apr. 3, 2009.
(60) Provisional application No. 61/101,135, filed on Sep. 29, 2008.
(60) Provisional application No. 61/043,967, filed on Apr. 10, 2008.
(60) Provisional application No. 61/042,145, filed on Apr. 3, 2008.

(51) Int. Cl. G09G 5/00

(52) U.S. Cl. 345/3.1; 345/1.1

(57) ABSTRACT

A system for displaying content on multiple electronic displays utilizing a single video player and transmitter. Some displays may show dynamic video and the remaining displays may show static images. Alternatively, every display may be showing static images. The player provides frames of video which may be encoded with unique display identifiers which direct the system to display the proper frames on the proper displays. The transmitter may be in wireless or hard-wired electrical communication with the display receivers. If using a hard-wired embodiment, the displays may be daisy-chained together to reduce the length of wire/cable needed.

### CROSS-REFERENCE TO RELATED APPLICATIONS

The present application is a non-provisional application and claims priority to co-pending application No. 61/101,135 filed on Sep. 29, 2008. This application is also a continuation in part of application Ser. No. 12/422,037 filed on Apr. 10, 2009 which claims priority to 61/043,967 filed on Apr. 10, 2008. This application is also a continuation in part of application Ser. No. 12/418,250 filed on Apr. 3, 2009 which claims priority to 61/042,145 filed Apr. 3, 2008. Each of these applications is herein incorporated by reference in its entirety.

### TECHNICAL FIELD

Exemplary embodiments relate to a system and method of providing video and audio content to multiple displays.

### BACKGROUND AND SUMMARY OF THE INVENTION

It is often desirable to be able to display a mixture of static video and dynamic video on a number of different displays. Traditionally this would be accomplished through the use of multiple players and transmitters. Each display would have an individual and unique player and transmitter associated with the display.

The traditional system for supplying content to multiple displays is cumbersome and expensive. The need to have a player and transmitter in association with each display increased the cost significantly. In addition, the space required to accommodate all the players and transmitters is extensive. As such, there is need for a more efficient system that allows content to be displayed on multiple displays using only a single player, where the content may include both dynamic and static video.

The system herein provides both dynamic and static video to multiple displays using a single player and transmitter. An exemplary embodiment of the system provides a player having a single output. The video feed is sent to a transmitter. The transmitter then sends the video feed to multiple displays by way of a receiver associated with each display. To achieve different content on each display, the video player or transmitter may embed the data header of the video frame with a display identifier. The receivers associated with each display read the display identifier embedded in the video frame. If the display identifier matches the identifier for the associated display (or one of the identifiers for the associated display), then the image is displayed. If the identifiers do not match, the receiver does not send the image to the display. The display continues to show the last image it received until a new image is obtained.

In addition to static video (still images), dynamic video may be provided by the video player. In this embodiment, the player may take a frame of video and update any of the static displays. This allows a single player to produce multiple static images while playing dynamic video over at least one display. It should be understood that the displays may be LCD, OLED, LED, plasma, projection displays, light emitting polymers, electroluminescence, or any other suitable electronic display. In addition, the components may be in wired or wireless communication with one another depending on the application. An exemplary embodiment may provide wireless communication between the transmitter and the various display receivers.

In other exemplary embodiments, the player may have a dual output where one output may be dedicated to dynamic video, while the other output may be used to refresh the static displays. In some of these embodiments, the dynamic video may not have an identifier in the header of the frames. The static image feed, however, may still need to have the identifier embedded in the header.

These systems may provide a cost effective method of displaying menu boards in restaurants, or advertising material in any public area. The system may provide a dynamic video feed on some displays while simultaneously providing static images on other displays. By eliminating multiple components from the traditional approach, the system may be cost effective for use where traditional systems were deemed cost prohibitive. The exemplary embodiments have the notable advantage of the ability to display content to a large number of displays using a single player and transmitter.

One skilled in the art should also recognize that audio associated with the video may also be supplied to the displays in the same manner. The system described herein may also utilize the video buffer system as described in U.S. application Ser. No. 12/422,037 filed on Apr. 10, 2009 incorporated herein as if fully rewritten. Using the embodiments herein with the video buffer system taught in the co-pending application ensures that video will continue to be displayed if there is an interruption in the signal transmission to the display receivers. The system described herein may also utilize the daisy-chain wiring method described in co-pending U.S. application Ser. No. 12/418,250 filed on Apr. 3, 2009 incorporated herein as if fully rewritten. This method reduces the amount of physical wire/cable that would be required for hard-wired installations of the exemplary embodiments herein. The displays are wired to one another (daisy chained) rather than having a wire/cable ran from each display back to the original transmitter.

Other systems, methods, features and advantages of the invention will be, or will become apparent to one with skill in the art upon examination of the following figures and detailed description. It is intended that all such additional systems, methods, features, and advantages be included within this description and be within the scope of the invention.

### BRIEF DESCRIPTION OF THE DRAWINGS

The following description includes discussion of various figures having illustrations given by way of example of implementations of embodiments of the invention. The drawings should be understood by way of example, not by way of limitation.

FIG. 1 is a diagram illustrating a previous approach to providing content to multiple displays.

FIG. 2 is a diagram illustrating an exemplary embodiment of the system for supplying content to multiple displays utilizing a single output player.

FIG. 3 is a diagram illustrating an exemplary embodiment of the system for supplying content to multiple displays utilizing a multiple output player.

### DETAILED DESCRIPTION OF THE EXEMPLARY EMBODIMENT(S)

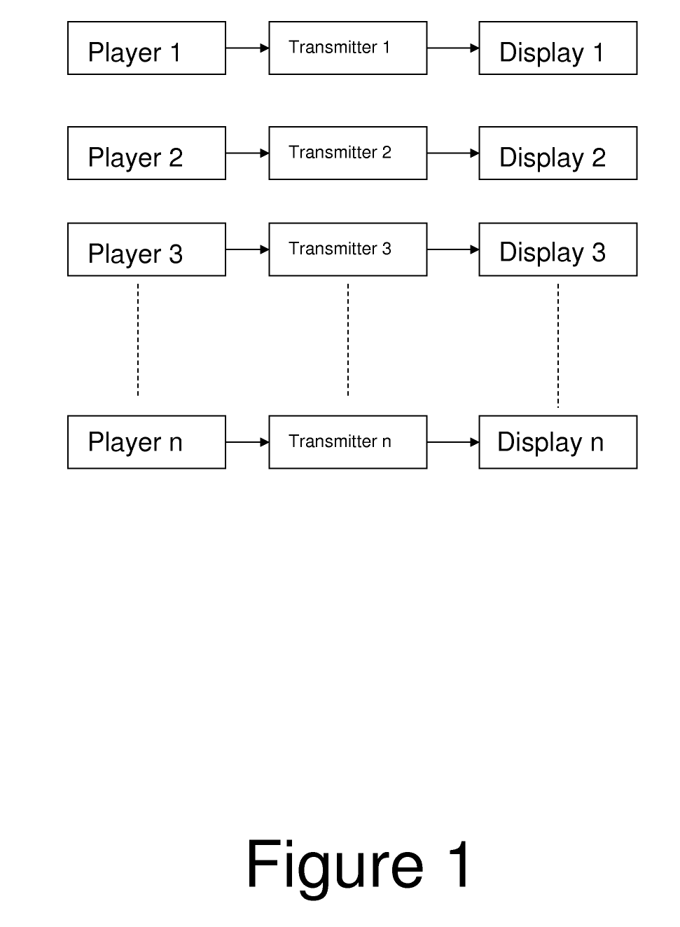

Traditionally digital signage has required complex wiring, a large number of components, and substantial space to provide content to multiple displays. FIG. 1 illustrates a traditional content delivery system. Previously, to display varying content to multiple displays each display needed its own player and transmitter. This configuration was cost and space prohibitive.

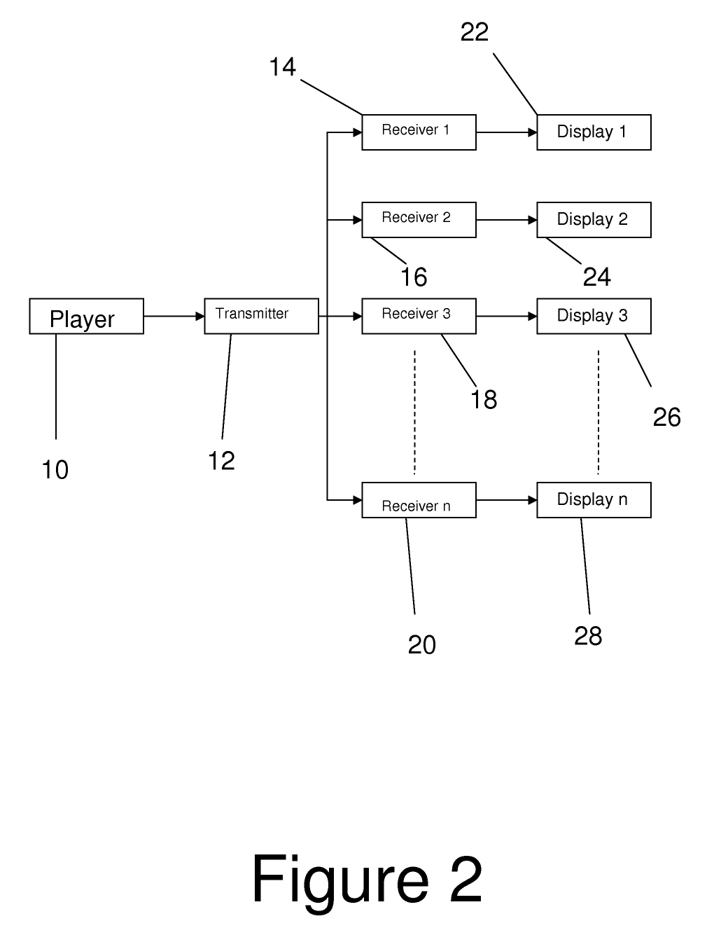

In digital signage applications having multiple displays, where some of said displays may contain static content while others may contain dynamic content, it is possible to have a single player 10 (shown in FIG. 2) control the content for all the displays versus individual players associated with each display (as shown in FIG. 1). FIG. 2 is a diagram illustrating an exemplary embodiment of the system where a single audio and video player 10 (hereinafter “player”) may be used to update multiple displays 22, 24, 26, and 28. As seen in FIG. 2 the player 10 may be in communication with a transmitter 12. The transmitter 12 may also be in communication with multiple receivers 14, 16, 18, and 20, using either hard wired (such as CAT-5 cable or any other suitable wire) or wireless connections.

Each receiver 14, 16, 18, and 20 may also be in communication with their respective displays 22, 24, 26, and 28. The displays 22, 24, 26, and 28 may be individually addressable by assigning a different display identifier to each display. Alternatively, a display may be associated with multiple identifiers. Although shown having four receivers 14, 16, 18, and 20 and four displays 22, 24, 26, and 28, any number of displays and receivers may be connected to the transmitter 12 in a similar manner.

To provide content to multiple displays 22, 24, 26, and 28 using a single player 10, the player 10 provides video (and sometimes audio) content to be displayed. The player 10 can provide only static video (still images), only dynamic video, or a mixture of both types of video. Initially, the system will be described with reference to a mixture of both types of video, although it should be easily recognized that an exemplary system can also display only one or the other.

Dynamic video is typically output at a certain frame rate, which may depend on the video source, bandwidth of the system, and the electronic displays on which it will be displayed. For example, for video at 30 fps, 30 frames (images) are provided for each second. Depending on the particular setup, the player 10 or transmitter 12 may divide the dynamic video signal into each frame and then compress each frame (compression may not be necessary for some systems—depending on bandwidth and the size of the video data). A central processing unit (CPU) may be used to carry out these functions and the CPU may be a separate unit or may be built into the player 10 or transmitter 12. Regarding the compression method, JPEG, MPEG, or JPEG 2000 are common formats for the frame/image compression although other types of compression may be used.

The player 10 or transmitter 12 may associate a header with each frame. The header may contain various bits of information including the instructions for de-compressing the frame and re-assembling it. In addition, the player 10 or the transmitter 12 may encode one or more display identifiers into the header for each frame. The display identifiers thus direct the system as to which displays are to be showing which images. The frame and header may collectively be known as a ‘packet.’

The transmitter 12 may then broadcast the packets to each of the receivers 14, 16, 18, and 20. Upon receiving the packets, the receivers 14, 16, 18, and 20 may then read the information contained within the headers. If the display identifier in the header matches one of the identifiers of the display 22, 24, 26, and 28 in association with the receiver 14, 16, 18, and 20 the receiver may then decompress the packet (if necessary) and send the image to the associated display.

If the display identifier does not match the display identifier of the associated display, the frame is not shown on the display 22, 24, 26, and 28. Each receiver 14, 16, 18, and 20 will continue to send the previously received image information until a new packet having a matching display identifier is received. To accomplish this, the receivers 14, 16, 18, and 20 or the displays 22, 24, 26, and 28 may have a storage medium to hold the last matching video frame. In this manner, a static image may be sent to a particular display (or displays) during one frame and this image may remain on the chosen display (or displays) until another image is sent. In advertising displays for example, a static image may remain on the display for a given time (30 seconds, 60 seconds, etc.) and the company may pay the advertising firm for exactly the amount of time that their advertisement was displayed. For informational purposes (i.e. airport terminals and sporting event scores), the displays may be updated with new static images whenever the information being displayed has changed (i.e. late/new arrivals at airports or scoring changes). Thus, with systems that are capable of sending out many packets/frames per second, it is easy to see that many displays can be controlled through a single location.

There may be a video buffer (storage medium) in electrical communication with each receiver and/or display. Some video buffers may be capable of storing large amounts of video data for display. Some embodiments described herein may utilize the video buffer system as described in U.S. application Ser. No. 12/422,037 filed on Apr. 10, 2009 incorporated herein as if fully rewritten. Using the embodiments herein with the video buffer system taught in the co-pending application ensures that dynamic video will continue to be displayed if there is an interruption in the signal transmission to the display receivers.

As mentioned above, it may be desirable to show dynamic video on at least one of the displays 22, 24, 26, and 28 rather than a static image. To accomplish this, the header for each dynamic video packet would contain the display identifier for the display(s) which is to show the dynamic video. The remaining displays which are showing static content may receive updated images by substituting one frame of static image for one frame of dynamic video. Stated another way, if the dynamic video was being transferred at 30 frames per second, in order to change the static image on a particular display, the player 10 would provide 29 frames of dynamic video and 1 frame of the static image in one second. The display which is showing the dynamic video would simply repeat the previous frame while the static image update is being sent. The absence of a new frame of dynamic video will be hardly noticeable (if noticeable at all) by an observer. This is especially true for higher frame rates (over 30 fps). As mentioned immediately above, the previous frame would be repeated, so there would be no ‘blank screen’ or ‘flicker’ that would be noticeable. The disruption of the dynamic video could be further reduced by updating the static images during a break in dynamic video or during a segment of dynamic video where there is little movement or change in the image. In these situations the surrounding frames are nearly identical, so repeating a previous frame would be even less noticeable to an observer.

Different embodiments may transmit packets at different rates. Thus, embodiments which are displaying dynamic video on at least one display may be transmitting packets relatively frequently (depending on the frame rate for example: 30, 60, or more/less packets each second). However, embodiments which are displaying only static video may transmit packets relatively infrequently (ex. one packet every 30 seconds, 60 seconds, or more). Further, some embodiments may display dynamic video for some period of time, followed by periods of only static video. This may occur especially in advertising systems where some companies may have dynamic video advertisements while others have static video advertisements. In these systems there may be periods where the packet transmission is occurring 30 times per second, followed by periods where the packet transmission is occurring only once each minute.

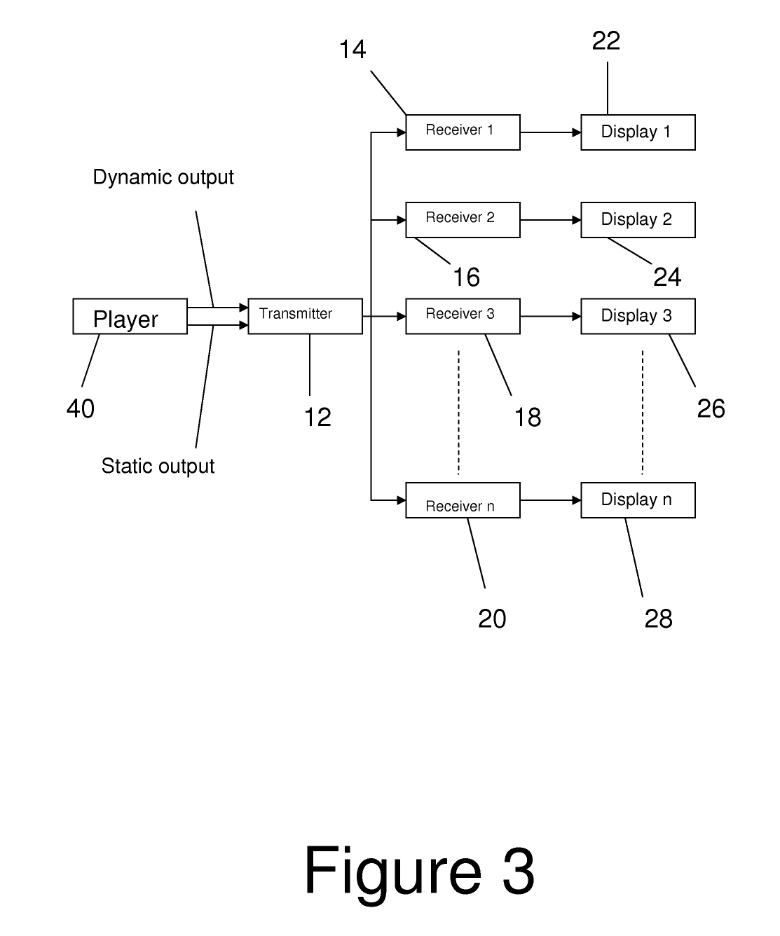

FIG. 3 is a diagram illustrating another embodiment of the system where a single audio and video player 40 having two outputs may be used to update multiple displays 22, 24, 26, and 28 showing a combination of both dynamic video and static images. Again, the player 40 may be in communication with a transmitter 12 which may also be in communication with multiple receivers 14, 16, 18, and 20. The player 40 outputs a dynamic video feed to the transmitter 12 for at least one display while also outputting a second data feed used to update the remaining displays showing a static image. In these types of arrangements, the dynamic video may be a steady stream of video which may be used as a ‘default’ for the majority of the displays where the static images may be sent as an override to the default of dynamic video. These embodiments may be used where a television feed is used fairly consistently with an occasional static image. For example, a bar or restaurant may want to display a television broadcast for an extended period of time (most likely in the evenings when sporting events or other popular broadcasts may be shown). However, during other times the bar or restaurant may choose to show static images for advertising purposes or for menu boards or specials (such as during the day when popular broadcasts may not be shown). For these embodiments, the arrangement in FIG. 3 may be beneficial as it may not require each frame of dynamic video to be encoded with display identifiers (and sometimes compressed). Instead, the steady stream can be sent as the default with an occasional static image packet interjected into the stream to override the default dynamic video. Thus, these embodiments may require less processing speed/power by the player and transmitter such that less expensive equipment could be used. Further, the dynamic video may be more easily sent in an uncompressed format to prevent any unwanted artifacts which can sometimes become present due to compression.

The static video output designated to update the remaining displays 22, 24, 26, and 28 may be encoded in the same manner as described above. However, if the dynamic video stream is used as the default, then the overriding static packets may take on several forms. A first form would be to send a packet which is intended to be displayed indefinitely (until another static packet is sent or until an instructional packet is sent directing the display to return to showing the dynamic video). A second form would be to provide instructions in the static packet header which details how long the static image should be displayed (until returning to the dynamic video default). Of course, the embodiments described in relation to FIG. 3 may also contain two separate players (one for the dynamic video and another for the static images) rather than a single player with two outputs.

The electrical connection between the transmitter 12 and the receivers for the various displays may be a hard-wired or wireless connection. If using a wireless connection, wireless routers can send the packets to the various receivers resulting in a very simple and clean installation. If using a hard-wired connection, actual wires would still need to be run from the transmitter 12 to the various receivers. In installations containing many displays, and especially where the displays are located far from the transmitter 12, the installation costs and the wiring itself can be very expensive. Thus, the wiring technique taught in co-pending U.S. application Ser. No. 12/418,250 filed on Apr. 3, 2009 may be used with some of the hard-wired embodiments. This application is herein incorporated by reference in its entirety. Using this technique, the receivers may be ‘daisy chained’ together, so that each display may only require a wire from an adjacent display as opposed to running a wire all the way from the transmitter. To accomplish this, a serializer/de-serializer (SerDes) technique is used. The signal originates as a parallel block with a clock and is serialized prior to being sent by the transmitter 12. The serial signal is then sent to a receiver where it is deserialized and the original parallel data and clock is recovered. Clock cleaning circuitry is then used to remove jitter and drive the display associated with the receiver. The signal is then serialized again and sent on to the next receiver in the daisy chain. This technique can be used to string many displays together without having to run individual wires back to the original transmitter 12. While many different types of cables (wiring) can be used, CAT 5 is inexpensive and can be used in an exemplary embodiment. The method can be practiced with both compressed and un-compressed video.

Those skilled in the art can also use the embodiments herein to send audio data along with the video data. It may be advantageous to send two packets of audio along with each packet of video. For example, if dynamic video is being sent at 30 fps (30 Hz), it may be advantageous to include two 60 Hz audio packets along with the 30 Hz video packet.

The embodiments herein disclosed are not intended to be exhaustive or to unnecessarily limit the scope of the invention. The embodiments were chosen and described in order to explain the principles so that others skilled in the art may practice the invention. Having shown and described embodiments, it will be within the ability of one or ordinary skill in the art to make alterations or modifications, such as through the substitution of equivalent materials or structural arrangements, or through the use of equivalent process steps, as to be able to practice the invention without departing from the spirit as reflected in the appended claims, the text and teaching of which are hereby incorporated by reference herein. It is the intention, therefore, to limit the invention only as indicated by the scope of the claims and equivalents thereof.

What is claimed is:

1. A system for displaying content on multiple electronic displays comprising:
a player which produces at least one video stream by outputting a plurality of frames associated with each video stream;
a transmitter in electrical communication with the player which encodes each frame with one or more display identifiers;
a plurality of receivers in electrical communication with the transmitter, which receives each frame from the transmitter and analyzes the frame's display identifiers and accepts the frame if the display identifier is acceptable, or rejects the frame if the display identifier is not acceptable; and
an electronic display in electrical communication with each receiver that displays the frame if accepted.

2. The display system of claim 1 wherein:
each receiver is associated with a single unique display identifier.

3. The display system of claim 1 wherein:
said electronic display repeats a previously accepted frame if the current frame is rejected.

4. The display system of claim 3 further comprising:
a storage medium in electrical communication with each electronic display which stores previously accepted frames.

5. The display system of claim 1 further comprising:
a compression device in electrical communication with the player which compresses each frame.

6. The display system of claim 1 wherein:
the electrical communication between the transmitter and receivers is a wireless electrical communication.

7. The display system of claim 1 wherein:
the electrical communication between the transmitter and receivers is provided by CAT 5 cable.

8. A system for displaying content on multiple electronic displays comprising:
a player which produces a plurality of video frames;
a first central processing unit which receives the frames from the player, compresses the frames, and encodes each frame with one or more display identifiers, resulting in a plurality of packets;
a transmitter which receives the packets from the CPU and wirelessly transmits the packets;
a plurality of receivers, each receiver is associated with a display identifier and receives the transmitted packets and analyzes the packet's display identifiers and
accepts the packet if the display identifier matches the receiver, or
rejects the packet if the display identifier does not match the receiver;
a second central processing unit (CPU) in electrical communication with each receiver which decompresses the packet if the packet was accepted; and
an electronic display in electrical communication with each second CPU which displays the decompressed packet if the packet was accepted and repeats the display of a previously accepted packet if the packet was rejected.

9. The display system of claim 8 further comprising:
a storage medium in electrical communication with each electronic display which stores previously accepted packets.

10. The display system of claim 8 wherein:
the electronic displays are liquid crystal displays.

11. The display system of claim 8 wherein:
the electronic displays are OLED displays.

12. A system for displaying content on multiple electronic displays, comprising:
a player providing a plurality of video frames as a parallel data stream, each frame having a display identifier,
serializer circuitry in electrical communication with the player which converts the parallel data stream into a serial data stream, and
a transmitter in electrical communication with the serializer circuitry which transmits the serial stream;
a first display assembly in electrical communication with the transmitter and having a display identifier, the assembly comprising:
a first display receiver which receives the serial data stream,
a first display de-serializer which converts the received serial data stream into a parallel data stream,
a first display central processing unit which analyzes the display identifier for each frame in the parallel data stream, and
accepts the frame if the display identifier matches the display identifier for the display assembly and
rejects the frame if the display identifier does not match the display identifier for the display assembly,
a first display which displays the frame if accepted and displays a previously accepted frame if rejected,
a first display serializer which converts the parallel data stream into a serial data stream, and
a first display transmitter which transmits the serial data stream; and
a second display assembly in electrical communication with the first display transmitter and having a display identifier, the assembly comprising:
a second display receiver which receives the serial data stream,
a second display de-serializer which converts the received serial data stream into a parallel data stream,
a second display central processing unit which analyzes the display identifier for each frame in the parallel data stream, and
accepts the frame if the display identifier matches the display identifier for the display assembly and
rejects the frame if the display identifier does not match the display identifier for the display assembly,
a second display which displays the frame if accepted and displays a previously accepted frame if rejected,
a second display serializer which converts the parallel data stream into a serial data stream, and
a second display transmitter which transmits the serial data stream;

13. The display system of claim 12 further comprising:
N display assemblies in electrical communication with the second display assembly where N is any positive integer.

14. The display system of claim 12 wherein any one of the display assemblies is a distribution display assembly having a transmitter which simultaneously transmits the serial data stream to a plurality of additional display assemblies.

15. The display system of claim 12 further comprising:
a clock cleaner within each display assembly which synchronizes the displays of each display assembly.

16. The display system of claim 15 wherein:
the transmission of each serial data stream takes place on CAT-5 cable.

17. The display system of claim 16 wherein:
each display is a liquid crystal display.

18. The display system of claim 16 wherein:
each display is an OLED display.

19. The display system of claim 16 further comprising:
a storage medium in electrical communication with each display which stores previously accepted frames.

20. A system for receiving and displaying video frames which have been encoded with one or more display identifiers, the system comprising:
a plurality of receivers, each receiver is associated with one or more display identifiers and receives the video frames and analyzes each frame's display identifiers and
accepts the frame if the display identifiers match, or
rejects the frame if the display identifiers doe not match; and
an electronic display in electrical communication with each receiver which displays the frame if it was accepted and repeats the display of a previously accepted frame if it was rejected.

21. The display system of claim 20 further comprising:
a central processing unit (CPU) in electrical communication with each receiver which decompresses the frame if it was accepted.

22. The display system of claim 21 further comprising:
a storage medium in electrical communication with each electronic display which stores previously accepted frames.
